(19) United States
(12) Patent Application Publication
(10) Pub. No.: US 2007/0197241 A1
(43) Pub. Date: Aug. 23, 2007

(54) USE OF TIMING AND SYNCHRONIZATION OF AN ORTHOGONAL FREQUENCY DIVISION MULTIPLEX IN COMBINED SATELLITE-TERRESTRIAL NETWORK

(75) Inventors: Rajendra Singh, Alexandria, VA (US); George Ron Olexa, Gainesville, GA (US)

Correspondence Address: DLA PIPER US LLP, P. O. BOX 9271, RESTON, VA, 20195, US

(73) Assignee: TELCOM VENTURES, LLC, ALEXANDRIA, VA (US)

(21) Appl. No.: 11/615,412

(22) Filed: Dec. 22, 2006

Related U.S. Application Data
(60) Provisional application No. 60/755,075, filed on Jan. 3, 2006.

(51) Int. Cl. H04Q 7/00; H04B 7/00; H04J 1/00

(52) U.S. Cl. 455/500; 455/59; 370/343; 370/480

(57) ABSTRACT

A system and a method of communicating a data signal in a network of geographically spread out transceivers including a plurality of transmitters. At least one of the transmitters is on a satellite. The plurality of transmitters communicate wirelessly with a receiver. Each of the plurality of transmitters transmits a copy of the data signal on a plurality of orthogonal sub-carrier frequencies to the receiver. The plurality of transmitters are synchronized so that the receiver receives the copies of the data signal substantially simultaneously.

### CROSS-REFERENCES TO RELATED APPLICATIONS

This application is based on and derives benefit of the filing date of the U.S. Provisional Patent Application No. 60/755,075, filed on Jan. 3, 2006, the contents of which are incorporated herein by reference.

### FIELD OF THE INVENTION

The present invention relates generally to signal transmissions, and relates specifically to a method and transmission system using orthogonal frequency division multiplex.

### BRIEF SUMMARY OF THE INVENTION

An aspect of the present invention is to provide a system and a method of transmitting a data signal using a plurality of transmitters. At least one of the transmitters is on a satellite and the plurality of transmitters are geographically spread out. The plurality of transmitters are configured to communicate wirelessly with a receiver, each of the plurality of transmitters transmitting a copy of the data signal on a plurality of orthogonal sub-carrier frequencies to the receiver. The plurality of transmitters are further configured to be synchronized so that the receiver receives the copies of the data signal substantially simultaneously.

A further aspect of the present invention is to provide a system and a method of communicating a data signal in a network of transceivers including a plurality of receivers. At least one of the receivers is on a satellite and the plurality of receivers are geographically spread out. Each receiver is configured to receive a copy of a data signal from a transmitter, the copy of the data signal being transmitted on a plurality of orthogonal sub-carrier frequencies. The copies of the data signal received by the receivers are employed to reconstitute the original data signal.

Throughout this application, including the claims, the word “transceiver” is intended to mean a transmitter, a receiver or a combination transmitter/receiver.

### BRIEF DESCRIPTION OF THE DRAWINGS

FIG. 1 illustrates a network system that combines coverage from both satellite and terrestrial elements, according to an embodiment of the invention;

FIG. 2 is an illustration of the effect of frequency selective fading;

FIG. 3 shows signals received from different sources, some of the signals having faded sub-carriers, and the resultant signal obtained after adding the received signals; and

FIG. 4 shows an example of a network system in an uplink configuration in which one or more receivers receive incomplete signal information, according to an embodiment of the present invention.

### DESCRIPTION OF EMBODIMENTS OF THE INVENTION

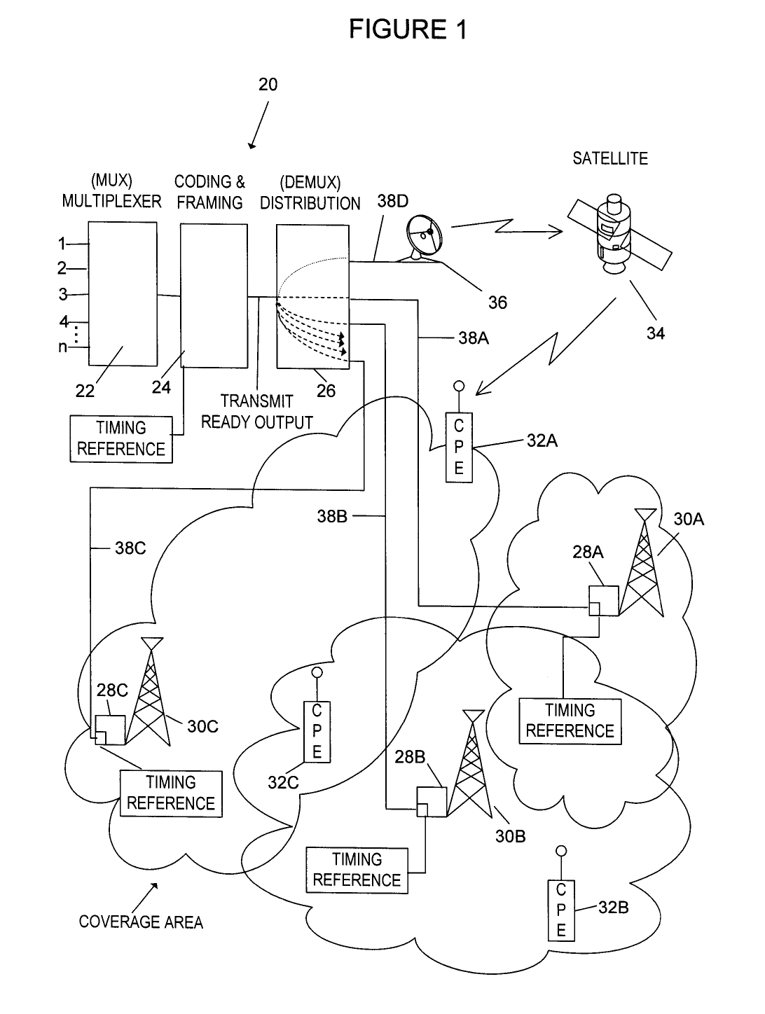

FIG. 1 illustrates a network system that combines coverage from a number of transceivers, such as both satellite and terrestrial elements, according to an embodiment of the present invention. In this case, a transceiver or customer premises equipment (CPE) is capable of receiving or transmitting both a satellite signal and a terrestrial wireless signal. The combined satellite-terrestrial network 20 comprises a multiplexer (MUX) 22, coding and framing device 24, demultiplexer (DEMUX) distribution unit 26, individual base transmit subsystem (BTS) 28A, 28B and 28C, transceivers 30A, 30B and 30C and transceivers 32A, 32B and 32C. The combined satellite-terrestrial network further comprises at least one satellite 34 and uplink system (UL) 36. The system can include any number of transceivers of any kind. For example, the system can include only satellite transceivers (i.e., transceivers on satellites).

The multiplexer 22 is configured to receive streams of data (1, 2, 3, 4, . . . , n). The multiplexer 22 is linked to coding and framing device 24. The multiplexer concatenates the streams of data (1, 2, 3, 4, . . . , n) and transmits the concatenated stream of data to coding and framing device 24. The transmitted stream of data is coded, interleaved and framed with coding and framing device 24.

The coding and framing device 24 is connected to distribution unit 26. The coded, interleaved and framed data stream is sent to the distribution unit 26. In the distribution unit 26, the data stream is “copied” as many times as necessary to feed each individual transceiver (e.g., terrestrial transceiver 30A, 30B and 30C) and transceiver on satellite 34. The distribution unit 26 distributes the copied transmission signals to BTS 28A, 28B and 28C and uplink system UL 36 via, respectively, transmission lines 38A, 38B, 38C and 38D. Transmission lines 38A, 38B, 38C and 38D can be any kind of signal transport systems, for example, terrestrial digital carriers such as optical fibers and copper lines, microwave signal transmission, laser signal transmission, etc. BTS 28A, 28B and 28C are connected to transceivers 30A, 30B and 30C which relay the transmission signals received to transceivers CPE 32A, 32B and 32C.

In FIG. 1, the terrestrial transceivers (i.e., BTS 28A coupled with transceiver 30A, BTS 28B coupled with transceiver 30B and BTS 28C coupled with transceiver 30C) are geographically spread out. At the terrestrial transceivers (i.e., BTS 28A coupled with transceiver 30A, BTS 28B coupled with transceiver 30B and BTS 28C coupled with transceiver 30C) the incoming feed data stream is buffered, referenced to a master timing reference signal derived from GPS or from an accurate standard reference, such as a cesium clock. The data stream is delayed by an amount appropriate to compensate for the round trip transit time of the satellite transceiver signal. The delayed signal is then processed into parallel streams which are fed to an orthogonal division multiplex (OFDM) modulator used to modulate the individual sub-channels on an OFDM carrier. The OFDM carrier is transmitted to each transceiver 30A, 30B and 30C which are used to provide radio coverage to designated coverage areas. Each CPE 32A, 32B and 32C listens for a signal on a channel, locks to the channel and starts decoding the OFDM signal stream. Each transceiver (BTS 28A coupled with transceiver 30A, BTS 28B coupled with transceiver 30B, BTS 28C coupled with transceiver 30C) is frequency referenced to the standard reference to insure that the center frequency of the OFDM sub-carriers is identical in each transmit location.

Similarly, the uplink UL 36, which receives signals from demultiplexer distribution unit 26, sends the signals to a transceiver on satellite 34. Specifically, at the uplink system UL 36, the incoming data stream is processed into parallel streams and sent to OFDM modulator for frequency modulation on an OFDM carrier. The OFDM carrier is transmitted by the uplink system 36 to the transceiver on satellite 34, where the OFDM carrier is converted to the downlink frequency and transmitted by the transceiver on satellite 34 back to earth in the coverage area defined by the satellite transceiver's antenna. The coverage area may include, for example, transceivers CPE 32A and CPE 32C.

This embodiment may be used to provide “broadcast” type services. A broadcast type service is a service in which identical content is delivered from the network to one or more users. The content is digitized, multiplexed with multiplexer 22, coded and framed with coding and framing device 24 and transmitted over one or more transmitting sites, for example terrestrial stations (BTS 28A coupled with transceiver 30A, BTS 28B coupled with transceiver 30B and BTS 28C coupled with transceiver 30C). The transmitted content is then received, decoded, demultiplexed with demultiplexer distribution unit 26, and converted to an appropriate format for presentation to the user, for example CPE 32A, CPE 32B and CPE 32C. In this embodiment, the same content is also independently delivered to the transceiver on satellite 34. In this way, the terrestrial transmitting sites (BTS 28A coupled with transceiver 30A, BTS 28B coupled with transceiver 30B and BTS 28C coupled with transceiver 30C) can be timed so as to accommodate the propagation delay time inherent in the round trip path to satellite 34 (i.e., the trip ground station/uplink system 36 to satellite 34 and satellite 34 to earth for reception by CPE 32A, CPE 32B and CPE 32C).

In the process of transmitting a signal from a transmitter (for example, BTS 28A) to a receiver (for example, CPE 32A), the signal may encounter reflections in the transmission path. In this situation, the receiver (CPE 32A) may receive a plurality of signals (for example, two signals) each of which carries the same information but shifted in time. As a result, the signal received by the receiver (CPE 32A) would be a sum of the two signals shifted in time relative to each other. For example, one received signal would correspond to a non-reflected signal while the other signal would correspond to a reflected signal. The difference in time between the two signals corresponds to the difference between the arrival time of the non-reflected signal and the arrival time of the reflected signal to the receiver due to path differences between the two signals.

In the case where the time difference (time delay) between the two signals approaches or is greater than the symbol duration, the receiver (CPE 32A) would receive a compounded signal corresponding to the sum of the two signals in which the symbols (bits) in the non-reflected signal and the symbols (bits) of the reflected signal can not be distinguished. As a result, the information carried by the signal sent by the transmitter may not be captured by the receiver as the receiver will “see” a substantially flat signal. Consequently, the presence of multipath reflections may negatively impact the transmission of signal with short symbol duration and hence renders the transmission of the signal intolerant to multipath reflections.

The use of orthogonal frequency division multiplex (OFDM) overcomes this intolerance of multipath reflection by dividing a channel into a plurality of sub-channels, i.e., sub-carriers, with narrower bandwidth, each of which are overlapped in an orthogonal relationship. The term orthogonal is used herein to mean “independent,” or are referenced in such a way that they are not interfering. Information can be sent on parallel overlapping sub-carriers, from which information can be extract individually. In one embodiment, the carrier may have, for example, a (sin x)/x shape. In OFDM, a single transmitter transmits on many different orthogonal frequencies (typically tens to thousands). Because the frequencies are closely spaced, each frequency has room for a narrow band signal. The signal is also divided into an equal number of parallel streams, which are independently modulated on these sub-carriers. Because the sub-channels have a narrower bandwidth than the bandwidth of the original signal, the symbol duration in each sub-channel is increased. In other words, the symbol duration of each signal in each sub-channel is greater than the symbol duration of the signal in the original channel.

By providing a narrower bandwidth sub-channel, which provides a longer symbol duration, the signal can be rendered more multipath tolerant. With a relatively longer symbol duration, the signal in each sub-channel (sub-carrier) may be subject to multipath time variations without loss of signal information. Indeed, the symbols of each signal in each sub-channel can be distinguished by the receiver even if there is a shift (difference) in time due to reflections. To achieve this result, the bandwidth of the sub-channel can be selected such that the symbol duration of each signal in each sub-channel is longer than any time difference that may result from multipath reflections.

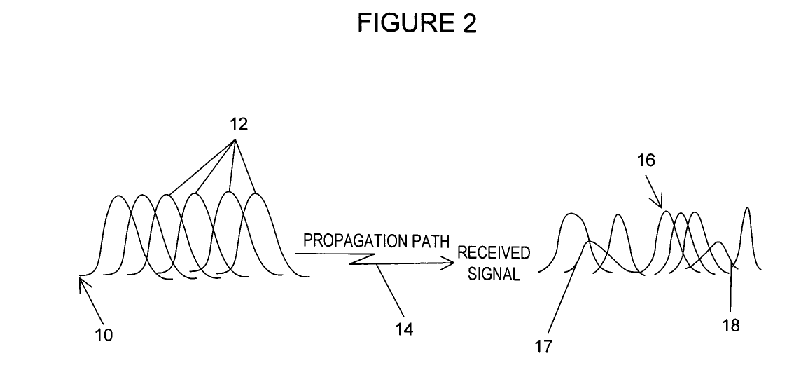

However, these independent narrow sub-carriers in corresponding sub-channels are affected by another propagation phenomenon, frequency selective fading. FIG. 2 is an illustration of the effect of frequency selective fading. Frequency selective fading occurs when reflections occur in the propagation path of the signal leading to random signal attenuation (or extinction) at specific frequencies. For example, as shown in FIG. 2, transmitted OFDM carrier 10 comprises a plurality of sub-carriers 12. When the OFDM carrier 10 is subject to reflections along propagation path 14, the OFDM carrier 10 would be received as OFDM carrier 16. Received OFDM carrier 16 may have some attenuated sub-carriers 17 and some missing sub-carriers 18. Indeed, propagation reflections or multipath reflections may cause, for example, certain frequencies of the signal to arrive at the receiver in multiples of half wavelength (λ/2) out of phase which leads to signal cancellation and loss or attenuation of certain spectral components.

Hence, due to potential frequency selective fading, a received signal may not contain copies of all sub-carriers or useful copies of all sub-carriers and the information they carry as some sub-carriers may be attenuated or extinct.

Because of frequency selective fading as discussed above, in OFDM certain sub-carriers can be located in faded areas of a channel. Frequency selective fading associated with a channel is unique to every individual propagation path. Each transmitter will produce a uniquely faded signal at every receiver. Therefore, if a receiver adds signals received from multiple transmitters, each being associated with unique faded sub-carriers, chances are sub-carriers attenuated or faded from one transmitter will not be attenuated in another transmitter or other remaining transmitters. Hence, the receiver will be able to reconstitute the original signal by summing or combining the signals received from different transmitters.

Indeed, in order to benefit from the different fading characteristics of each signal emitted by each transmitter (BTS 28A coupled with transceiver 30A, BTS 28B coupled with transceiver 30B and BTS 28C coupled with transceiver 30C and/or satellite 34) the signals should be timed or coordinated so that the signals arrive in the covered area substantially simultaneously or at least within the time interval defined by the symbol duration. For example, if each sub-carrier is 10 KHz wide and carries 1 bit/Hz, the symbol duration is 100 μs ( 1/10000 bps). So long as the system elements are time synchronized so that all data is delivered to the coverage area with a delay of no more than 100 μs (0.1 milliseconds), the receiver (for example CPE 32A) will receive the content of all transmitted signals as identical.

Since each individual transceiver (BTS 28A coupled with transceiver 30A, BTS 28B coupled with transceiver 30B, BTS 28C coupled with transceiver 30C and/or the satellite 34) have all been timed identically and operate with little frequency drift (due to being referenced to an identical source), the CPE (e.g., 32A, 32B, 32C) sees all signals within its bandpass as identical. Thus, the signals from the one or more terrestrial transceivers (BTS 28A coupled with transceiver 30A, BTS 28B coupled with transceiver 30B and BTS 28C coupled with transceiver 30C) and the satellite 34 effectively provide signal diversity to the transceiver CPE (e.g., 32A, 32B, 32C).

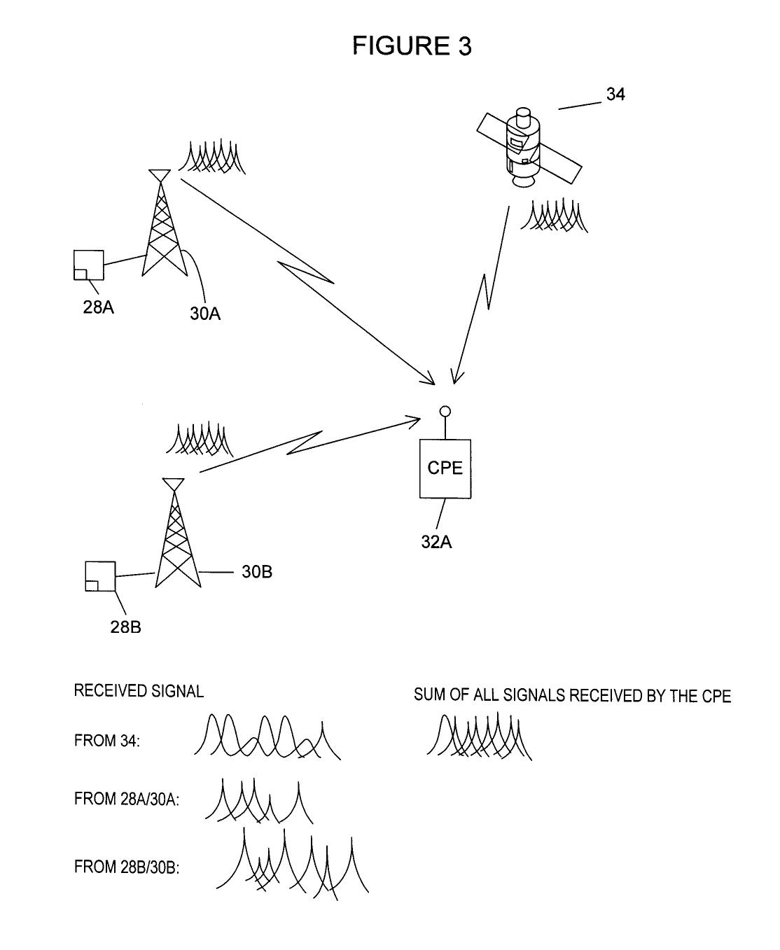

This signal diversity allows the transceiver CPE (e.g., 32A, 32B, 32C) to receive sub-channels from one source (for example from base station 28A coupled to transmitter 30A) which appear faded or nulled out by frequency selective fading from when sent by other sources (for example from base station 28B coupled to transceiver 30B and from satellite 34), as illustrated in FIG. 3. As shown in FIG. 3, by adding all the signals received from the different sources (BTS 28A coupled to transceiver 30A, BTS 28B coupled to transceiver 30B and satellite 34), the transceiver (e.g., CPE 32A) would be able to reconstitute all the sub-channels present in the original OFDM signal prior to transmission.

Also, coding and interleaving may help to insure that information contained in attenuated or lost (extinct) sub-carriers can be extracted from data contained in the remaining sub-carriers. Coding may include modifying a signal spectrum to increase the information content so as to provide redundancy of the information by including one or more copies of a same data. The goal of channel coding is to improve bit error ratio (BER) performance by adding redundancy to the transmitted data to obtain a coded bit stream of data. Channel coding includes adding redundant bits to the signal to enable error detection and/or error correction. Interleaving is used to scatter the redundant data bits over the plurality of sub-carriers so that if one or more sub-carriers are faded or lost, the redundant data bits can be found in another sub-carrier or other sub-carriers that did not suffer from selective fading. Interleaving is a permutation in which bits are permuted in a certain way and at a receiver, reverse permutation is performed. A common interleaving method is block interleaving. In block interleaving, data is written into a matrix row-by-row and read out column-by-column. The framing may include, for example, appropriate timing references that identify a beginning and an end of a frame as well as provide a synchronization signal that can be used by the transceiver (CPE) to accurately lock into the transmitted data stream.

One aspect of this embodiment is the use of frequency and time references common to all transceivers which allow the CPE to see multiple signals as a single broadcast rather than as interference. This may be especially useful when dealing with satellite delivered signals in a system with multiple satellites or mixed satellite terrestrial operations because the time delay of the satellite signals arrival is both long and variable depending upon the area of the earth illuminated.

For example, when a satellite and terrestrial systems are timed so that the content on the signals from each transmitter in a plurality of geographically spread out terrestrial transmitters or each transmitter in a combination of one or more geographically spread out terrestrial transmitters and one or more satellite transmitters, arrive in a coverage area contemporaneously, the receiver may benefit from the different fading characteristics of each signal by utilizing the least impaired sub-channel from each source, i.e., each transmitter. This allows, among other things, the receiver to lower its bit error rate (BER).

Therefore, delivering content or information on a multi-segment system which includes one or more satellite transmitters and/or one or more geographically spread out terrestrial transmitters allows the receiver to receive multiple independently faded signals and allows the receiver to capture sub-carriers that would otherwise be faded or lost if delivered only by a single transmitter. As a result, the quality of the multi-segment system can be improved as compared to the quality of a system, which transmits the content from one source (i.e., one transmitter) exclusively. In addition, coverage and user experience with the multi-segment system may also be enhanced as compared with coverage and user experience with a system, which transmits the content from one source exclusively.

In another embodiment of the present invention, the above described network system can be optimized to provide a two way data communications (for example or digitized voice communications) between independent users and the network. In this embodiment, the network can be designed to overcome frequency selective fading in much the same manner as the previously described network system. The main difference between the “broadcast” network system and a “two-way” network system is that in the case of the two-way system, each CPE (which acts as a transceiver) can receive and send a unique data content. For this reason, the geographically spread out terrestrial stations (BTS 28A, BTS 28B and BTS 28C) and transceiver on satellite 34 do not provide a common data content, but instead provide individualized data content as may be needed by individual users (CPE 32A, CPE 32B and CPE 32C).

Similar to the broadcast system, signal fading and its associated signal impairment effects may also be present in a two-way system. At any point in space, a transceiver CPE (32A, 32B, 32C) can receive a signal that is impaired to some extent by the fading effects of multipath. Hence, similarly to the broadcast system, these effects can be mitigated if the CPE (32A, 32B, 32C) can receive time and frequency aligned signals from disparate sources.

A difference between a broadcast system supporting a one-way communication and a system supporting a two-way communication is the additional need for the two-way communication system to monitor individual communications to determine whether a particular CPE can be provided improved service by utilizing multiple transmitters or system elements so as to increase the viability of a communication channel. If a receiver (CPE) determines that excessive data errors occur from one transmitter, the CPE can request the network system to transmit on multiple geographically spread out transmitters.

The operation of a forward link (i.e., BTS to CPE or satellite to CPE) for the two-way network system, from the standpoint of synchronization and frequency reference, are similar with those discussed above in a one-way network system. Since the two-way network system has also a reverse link in addition to the forward link (downlink), the reverse channel (uplink) must be synchronized as well.

Indeed, the downlink delivering a data bitstream is timed and referenced to a system master timing and frequency reference (e.g., GPS or cesium standard). Therefore, in order to receive the content (the data bitstream), the transceiver CPE synchronizes to the incoming bitstream. Specifically, the CPE uses a timing and a frequency reference derived from this bitstream and carrier (i.e., downlink carrier) as a reference to synchronize itself to the system uplink (i.e., CPE to BTS or CPE to satellite) requirements. The transceiver CPE “listens” to the incoming carrier (downlink carrier) and shifts its frequency so as to accurately align its operating center frequency with the transmitted center frequency of the incoming signal (downlink carrier). This frequency reference is also used to derive a transmission frequency for the CPE to generate its uplink carrier to allow the CPE (which acts as transmitter) to communicate with a receiver (for example, a BTS or a satellite). Timing is also derived from the downlink by using the synchronization bits in the downlink to accurately time align both the receiver and transmitter.

Unlike the downlink where one receiver (e.g., CPE 32A) receives and sums or combines the signals provided by multiple transmitters (e.g., BTS 28A, 28B, 28C, satellite 34), in the uplink configuration there are multiple independent geographically spread out receivers (e.g., BTS 28A, 28B, 28C, receiver on satellite 34) listening to a single transmitter (e.g., CPE 32A). Therefore, in the uplink configuration, any one or more of the receivers BTS 28A, 28B, 28C and/or receiver on satellite 34 may receive an impaired version of the transmission. As a result, a reconstruction of the transmission signal may need to be accomplished at a common point in the network system downstream of the receivers BTS 28A, 28B, 28C and/or receiver on satellite 34. At the common point downstream of the receivers BTS 28A, 28B, 28C and/or receiver on satellite 34, the data received by each independent receiver can be buffered, compared, analyzed, and used to best reconstruct the original transmission signal.

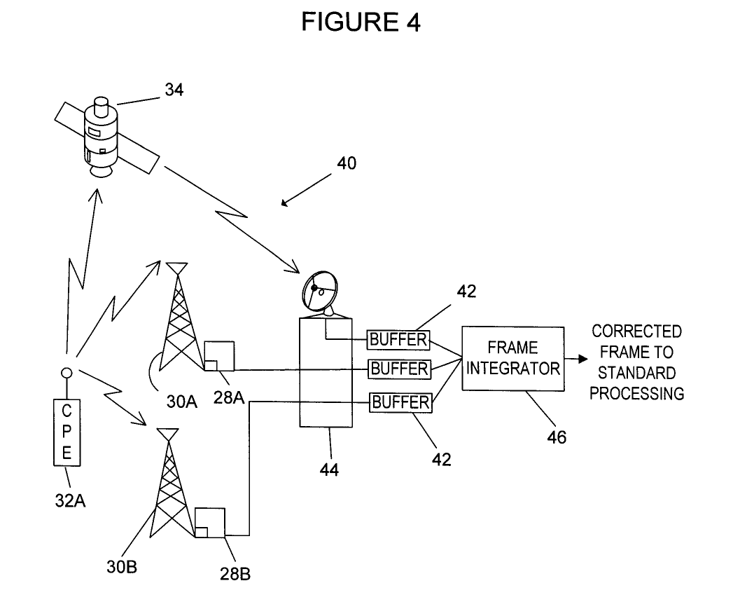

FIG. 4 shows an example of a network system in an uplink configuration in which one or more receivers receive incomplete signal information, according to an embodiment of the present invention. As illustrated in FIG. 4, in network system 40, each receiving site (transceiver 30A coupled to BTS 28A, transceiver 30B coupled to BTS 28B and satellite 34) receives an impaired copy of the original transmission signal transmitted by transmitter (CPE 32A). The copies are impaired due to the loss of certain sub-carriers to frequency selective fading. The network system 40 utilizes an error detection algorithm, such as a cyclic redundancy check (CRC) code, to check for errors on the content of each sub-carrier. Error free sub-carriers have their information stored in a frame buffer 42. Sub-carriers that have errors have null characters inserted in the appropriate bits of the frame. The received frame with error free and null characters is forwarded to the central control complex 44 and stored in a buffer 42.

Each receiving site (e.g., transceiver 30A coupled to BTS 28A and transceiver 30B coupled to BTS 28B and/or satellite 34) involved as a receiver forwards the unique error free information it receives a corresponding buffer 42. After all sites and satellites have forwarded their respective signal information, the frames in each buffer 42 are compared, and a new frame is constructed by combination unit 46 (e.g., a frame integrator) using the error free content from one or more of the receiving sites. If errors still exist, frame level error correction is used to correct any remaining errors.

By using this method, the overhead used by the system for coding and error correction can be reduced. Indeed, since the system no longer relies on a single receiving point which may relay incomplete or corrupted information, the system can rely on a plurality of receiving points to “reconstruct” and deliver a signal information with substantially reduced errors without heavily relying on system coding and error correction algorithms. Furthermore, the use of multiple receivers allows for independent reception of uncorrelated signals. As a result, each receiver may be able to “see” a uniquely faded signal and be able to compare the received faded signal with other signals received by remaining receivers. Using this comparison, each receiver may be able to improve upon rebuilding an error free received frame.

Although the network system is described herein in a configuration using seven transceivers (three BTSs, one satellite and three CPEs), it must be appreciated that a configuration with any number of transceivers (e.g., any number of BTSs, any number of satellites and any number of CPEs) is also contemplated herein and hence falls within the scope of the present invention.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

Moreover, the method and apparatus of the present invention, like related apparatus and methods used in the telecommunication arts are complex in nature, are often best practiced by empirically determining the appropriate values of the operating parameters, or by conducting computer simulations to arrive at best design for a given application. Accordingly, all suitable modifications, combinations and equivalents should be considered as falling within the spirit and scope of the invention.

In addition, it should be understood that the figures, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method of transmitting a data signal from a plurality of transmitters to a receiver, comprising:
operating each one of the plurality of transmitters to transmit a data signal on a plurality of orthogonal sub-carrier frequencies to the receiver, wherein at least one of the transmitters is on a satellite and the plurality of transmitters are geographically spread out, the receiver receiving an impaired copy of the data signal from at least one of the plurality of transmitters; and
synchronizing the plurality of transmitters so that the receiver receives impaired copies of the data substantially simultaneously, wherein the receiver employs the impaired copies of the data to reconstitute the data signal.

2. The method according to claim 1, wherein the receiver integrates the impaired copies of the data to reconstitute the data signal.

3. The method according to claim 1, wherein the synchronizing of the plurality of transmitters includes timing the transmitters relative to a time reference.

4. A method of transmitting a data signal from a transmitter to a plurality of receivers, comprising:
operating the transmitter to transmit a data signal on a plurality of orthogonal sub-carrier frequencies to the plurality of receivers, wherein at least one of the receivers is on a satellite and the plurality of receivers are geographically spread out, at least some of the receivers receiving an impaired copy of the data signal;
comparing the impaired copies of the data signal; and
combining the impaired copies of the data so as to reconstitute the data signal.

5. The method according to claim 4, further comprising buffering the impaired copies of the data signal.

6. The method according to claim 4, further comprising analyzing the impaired copies of the data signal.

7. The method according to claim 4, wherein the receivers receiving the impaired copy of the data signal are configured to rebuild a substantially error free copy of the data signal using the comparison between the impaired copies of the data signal.

8. A system for communicating data signals in a network of transceivers, comprising:
a receiver; and
a plurality of transmitters configured to communicate wirelessly with the receiver,
wherein at least one of the transmitters is on a satellite and the plurality of transmitters are geographically spread out,
wherein the plurality of transmitters are configured to transmit a data signal on a plurality of orthogonal sub-carrier frequencies to the receiver, the receiver receiving an impaired copy of the data signal from at least one of the plurality of transmitters,
wherein the plurality of transmitters are configured to be synchronized so that the receiver receives impaired copies of the data substantially simultaneously, and
wherein the receiver is further configured to employ the impaired copies of the data to reconstitute the data signal.

9. The system according to claim 8, wherein the receiver is further configured to integrate the impaired copies.

10. The system according to claim 8, wherein the plurality of transmitters are configured to be synchronized relative to a time reference.

11. A system for communicating data signals in a network of transceivers, comprising:
a plurality of receivers, wherein at least one of the receivers is on a satellite and the plurality of receivers are geographically spread out; and
a transmitter configured to communicate wirelessly with the plurality of receivers, the transmitter being configured to transmit a data signal on a plurality of orthogonal sub-carrier frequencies to the plurality of receivers, at least some of the receivers receiving an impaired copy of the data signal; and
a combination unit in communication with the plurality of receivers, the combination unit being configured to combine the impaired copies of the data so as to reconstitute the data signal.

12. The system according to claim 11, further comprising a buffering device in communication with the plurality of receivers, the buffering device being configured to buffer the impaired copies of the data signal.

13. The system according to claim 12, further comprising a comparing device in communication with the buffering device, the comparing device configured to compare the impaired copies of the data signal.

14. The method according to claim 13, wherein the receivers receiving the impaired copy of the data signal are configured to rebuild a substantially error free copy of the data signal using a result of the comparison between the impaired copies of the data signal output by the comparing device.

15. A network of transmitters, comprising:
a plurality transmitters configured to communicate wirelessly with a receiver,
wherein at least one of the transmitters is on a satellite and the plurality of transmitters are geographically spread out, and each of the plurality of transmitters is configured to transmit a copy of a data signal on a plurality of orthogonal sub-carrier frequencies to the receiver, and
wherein the plurality of transmitters are configured to be synchronized so that the receiver receives the copies of the data signal substantially simultaneously.

16. A network of receivers, comprising:
a plurality of receivers, wherein at least one of the receivers is on a satellite and the plurality of receivers are geographically spread out, and each receiver is configured to receive a copy of a data signal from a transmitter, the copy of the data signal being transmitted on a plurality of orthogonal sub-carrier frequencies; and
a combination unit in communication with the plurality of receivers, the combination unit being configured to combine the copies of the data signal received by the receivers.
